(19) United States
(12) Patent Application Publication
(10) Pub. No.: US 2015/0026079 A1
(43) Pub. Date: Jan. 22, 2015

(54) SYSTEMS AND METHODS FOR DETERMINING PACKAGES OF LICENSABLE ASSETS

(71) Applicant: Patent Properties, Inc., Stamford, CT (US)

(72) Inventors: Jay S. Walker, Ridgefield, CT (US); Jonathan E. Ellenthal, Wilton, CT (US); Paul Citarella, Norwalk, CT (US); Dipanjan Nag, Skillman, NJ (US); Jesse Stuart, Brooklyn, NY (US); Jessica Morton, Philadelphia, PA (US)

(21) Appl. No.: 14/335,909

(22) Filed: Jul. 20, 2014

Related U.S. Application Data
(60) Provisional application No. 61/856,761, filed on Jul. 21, 2013.

(51) Int. Cl. G06Q 50/18; G06Q 30/00

(52) U.S. Cl. CPC G06Q 50/184; G06Q 30/00
USPC 705/310

(57) ABSTRACT

In accordance with some embodiments, systems and methods provide for assembling a patent package for a product by analyzing text descriptive of the product, determining a plurality of patents which are relevant to the product and determining a subset of the patents to be licensed patents and the remainder to be not licensed patents. In accordance with some embodiments a relevancy score may be determined for each of the patents determined to be relevant and a portion of a price for the patent package may be apportioned to each patent in the patent package based on the relevancy score of the patent. In accordance with some embodiments, the portion of the price for a patent may be determined to be a license royalty if the patent is a licensed patent and an amount of premium for future financial aid if the patent is a not licensed patent.

### CROSS-REFERENCE TO RELATED APPLICATIONS AND/OR CLAIM OF PRIORITY

This application claims benefit and priority to, and is a non-provisional of, U.S. Provisional Patent Application No. 61/856,761 filed on Jul. 21, 2013 and titled “SYSTEMS AND METHODS FOR PATENT LICENSING”, the entirety of which is hereby incorporated by reference herein.

### BACKGROUND

There exist many inefficiencies in the ability of businesses which provide products and/or services to identify and obtain licenses to the intellectual property (e.g., such as rights set out in the claims of a patent) of others which may be relevant to such products and/or services. Many businesses would prefer to acquire a license to such rights, if such license was available on reasonable and efficient terms, in order to acquire peace of mind from potential litigation or negotiations for such license in the future; at the very least such businesses would appreciate receiving aid in defending themselves against allegations of infringement of non-licensed patents. At the same time, many patent owners or licensors who have rights in patent or other forms of intellectual property (which rights have typically been obtained at significant monetary investment) have no efficient or reasonable forum for identifying products and/or services of others which are relevant to the rights and the providers of which may benefit from licensing such intellectual property.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of a system according to some embodiments;

FIG. 2 is a block diagram of an apparatus according to some embodiments;

FIG. 3 is an example table storing data useful in a system according to one or more embodiments described herein.

FIG. 4 is an example table storing data useful in a system according to one or more embodiments described herein; and

FIG. 5 is a flow diagram of a method according to some embodiments.

### DETAILED DESCRIPTION

Described herein are systems, methods and articles of manufacture (e.g., non-transitory computer-readable media) which provide for, in accordance with some embodiments, (i) identifying, for a given product, relevant patents; and (ii) arranging a package of such relevant patents to be offered for license or other terms to an entity associated with such product (e.g., a supplier, designer, manufacturer or seller of the product or a component of the product, referred to as a “product provider” herein). In accordance with some embodiments, such a package may include (i) a plurality of patents which are determined to be relevant to the product (e.g., to at least one feature of the product) and which, under the terms of the package, will be licensed (e.g., non-exclusively) to the product provider; and (ii) a plurality of patents which are determined to be relevant to the product but which the system does not have licensing or sub-licensing rights (“not licensable patents” herein) but for which aid will be provided to the product provider in accordance with one or more defined terms. Patents which are included in a package of patents of a product provider but which are not licensed to the product provider as part of the patent package (even if they are licensable by the Patent Licensing Service under certain circumstances) are referred to herein as not licensed patents herein.

In accordance with some embodiments, the aid defined in a package may be, for example, a contractual obligation to provide aid in the form of insurance or a warranty if an infringement action is initiated against the product provider based on a not licensed package patent, the infringement action being initiated by an entity who is the assignee or licensee of the patent or which otherwise has the right to enforce the patent (referred to as a “patent enforcer” herein). For example, at least a portion of the attorney's fees and/or other legal costs incurred by the product provider in defending against or responding to the infringement action may be paid for or reimbursed if an infringement action is initiated against the product provider based on a non-licensed patent included in the package during the term of the package. In another embodiment, the aid may be in the form of information to be provided to the product provider to help the product provider defend against or respond to the infringement action (e.g., information about the litigation history of the patent being asserted, information about other product providers against whom an infringement action has also been initiated based on the same patent). An infringement action being initiated may comprise, for example, a letter from a patent enforcer associated with the patent being received by the product provider (e.g., a “demand” or “cease and desist” letter or an offer to discuss a license to the patent) and, in accordance with some embodiments, is not limited to formal legal proceedings alleging patent infringement being initiated against the product provider.

It should be noted that the term “product” as used herein, unless clearly indicated otherwise, refers to a good (e.g., a thing produced by labor, a software application, a component of a larger good), process or service, tangible or intangible, whether existing in the real world or in a virtual environment. In accordance with some embodiments, a product may be any good, article, service, process, method, activity, by-product, apparatus, article of manufacture (e.g., software on a tangible medium) and/or signal which may be the subject of a patent. A product may refer to a component or feature of a product. The product may be already available in the commerce, publicly available or a product in development. Any reference herein to a “product” may be interpreted as a reference to any of the foregoing which may comprise a product (e.g., a feature of a product or a service).

Also described herein are systems, methods and articles of manufacture (e.g., non-transitory computer-readable media) which, in accordance with some embodiments identify, for a given patent, at least one relevant product (e.g., products which may infringe or fall within the scope of one or more claims of the patent) and includes such patent into a respective package of patents, either as a patent to be licensed or a patent for which aid is provided (e.g., for which infringement insurance or a warranty is provided). In accordance with some embodiments, a package including a plurality of patents relevant to the product may be created and offered to a product provider associated with the at least one relevant product.

Also described herein are systems, methods and articles of manufacture which, in accordance with some embodiments, calculate an appropriate package price for a package of patents to be licensed. For example, such a package price may be based on royalty parameters previously agreed upon between the system and the owner or patent enforcer of each respective patent to be included in a given package.

In accordance with some embodiments, a package price or range of process for a package is predetermined or capped and a portion of the package price is allocated among the patents (whether it be the licensed patents included in the package or the not licensed package patents). In accordance with some embodiments, such an allocation is based on at least one relevancy score determined for the patent. Various methodologies for determining at least one relevancy score for a patent (e.g., with respect to a particular product) are described herein.

In accordance with some embodiments, systems, methods and articles of manufacture provide for generating a package of patents to include in an offer to a product provider for at least one product by: (a) receiving at least one text comprising a description of a product; (b) analyzing the text to identify at least one feature of the product, thereby identifying at least one feature of the product; (c) searching, for the at least one feature of the product, a memory storing information describing a plurality of patents to identify a plurality of patents related to the at least one feature, thereby identifying a plurality of relevant patents which are relevant to the product; (d) determining, for each patent of the plurality of relevant patents, a respective relevancy score; (e) selecting a subset of the plurality of patents based on the respective relevancy scores determined for each patent of the plurality of relevant patents, the subset comprising a predetermined number of patents having the relatively highest relevancy score, thereby determining a set of package patents to include in an offer to a product provider associated with the product; (f) determining which patents of the set of package patents are included in an inventory of licensable patents, thereby identifying at least one licensed patent to include in the offer; (g) determining the remainder of the patents of the set of package patents to be at least one not licensed patent to include in the offer; and (h) outputting to the product provider the offer, the offer comprising a benefit to be provided to the product provider in exchange for a payment from the product provider, the benefit comprising a non-exclusive license to the at least one licensed patents and an agreement for aid to be provided to the product provider in an event of an infringement action initiated against the product provider based on the at least one not licensed patents.

In some embodiments, a relevancy score (e.g., a patent-to-product correlation result) can be used for recommending services or component of a license and/or infringement insurance agreement. A user, software or computer-implemented process may function to recommend or identify one or more patent rights to be licensed in a package license or aid to be provided with respect to one or more patents which are not licensed, as described in accordance with various embodiments. Also described herein are methodologies via which a user, software or computer-implemented process may accept or implement the recommended license package and pay fees (e.g., license royalties and/or insurance premiums) in accordance therewith.

The foregoing and other features, aspects and advantages of various embodiments are described in detail below with reference to the drawings, which are intended to illustrate and not to limit the invention(s). Certain aspects, advantages, and novel features of the invention(s) are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

Although several embodiments, examples and illustrations are disclosed below, it will be understood by those of ordinary skill in the art that the invention(s) described herein extend(s) beyond the specifically disclosed embodiments, examples and illustrations and includes other uses of the invention(s) and obvious modifications and equivalents thereof. Embodiments of the invention(s) are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the invention(s). In addition, embodiments of the invention(s) can comprise several novel features and it is possible that no single feature is solely responsible for its desirable attributes or is essential to practicing the invention(s) herein described.

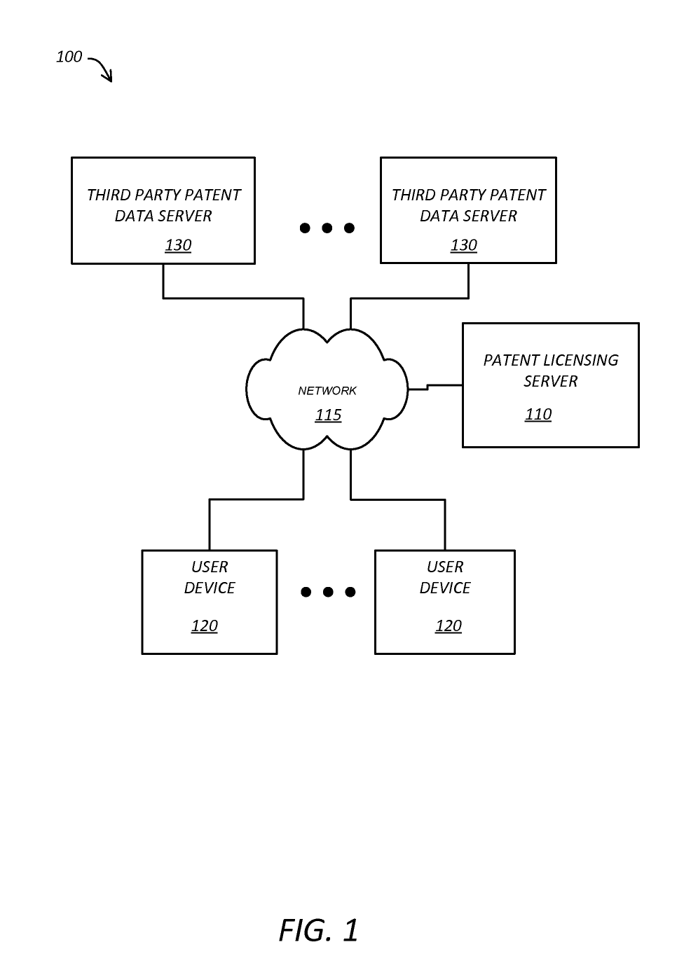

Referring now to FIG. 1, illustrated therein is an example system 100 consistent with one or more embodiments. The system 100 comprises a Patent Licensing Server 110, a plurality of User Devices 120, and a plurality of Third Party Patent Data Servers 130. The system 100 is one example embodiment of a system which may be operable to facilitate at least some embodiments described herein. In other words, the system 100 may be useful in facilitating a patent license or terms of financial aid to be provided in association with a patent (e.g., financial aid services in the form of infringement insurance or warranties regarding specified patents which are not licensed patents in a patent package).

In accordance with some embodiments, a User Device 120 may be operated by or on behalf of patent owners, patent enforcers and/or product providers, any of whom may access the services of the Patent Licensing Server 110. In accordance with some embodiments, a Third Party Patent Data Server 130 may be operated by or on behalf of an entity which stores or provides data or services which may be useful in at least some processes or methodologies performed by the Patent Licensing Server 110. For example, a Third Party Patent Data Server 130 may comprise one or more servers which store data describing one or more issued patents or pending patent applications. In some embodiments, a Third Party Patent Data Server 130 may be a server generally open to the public for searching data about patents (e.g., such as the United States Patent Office (USPTO) patent database). In another example, a Third Party Patent Data Server 130 may comprise one or more servers of a private or proprietary network or service, which the Patent Licensing Server may have permission (e.g., through a license agreement or subscription) to access.

In accordance with one embodiment, the system 100 may facilitate the provision of various tools and resources to allow a patent right owner or patent enforcer to grant a license (e.g., a non-exclusive license) to a patent by allowing the patent to be included in multiple patent packages provided to various product providers which are associated with products to which the patent is relevant. In accordance with some embodiments, the system 100 may allow a product provider to subscribe to (e.g., on a monthly payment basis) or purchase a patent package, for a particular product, the package consisting of at least one of (i) a license (e.g., a non-exclusive license) to a plurality of patents determined to be relevant to at least one feature of the product; and (ii) a right to receive from the patent licensing service certain pre-defined aid (e.g., reimbursement or payment of at least a portion of legal costs associated with defending against an infringement action) with respect to other specified patents in the package.

In some embodiments, one or more of these User Devices 120 may be operable to communicate with Patent Licensing Service 110 via a network 115. The network 115 may comprise, for example, a mobile network such as a cellular, satellite or pager network, the Internet, a wide area network, another network or a combination of such networks. It should be understood that although not shown in FIG. 1, other networks and devices may be in communication with any of the devices of system 100 and/or that network 115 may comprise two or more networks operable to facilitate the routing of communications among the devices of system 700. For example, in one embodiment, both the Internet and a wireless cellular network may be involved in routing communications among two or more components of the system 100.

In some embodiments, additional devices that are not show in FIG. 1 may be part of a system 100. For example, one or more servers operable to serve as wireless network gateways or routers may be part of system 100. In other embodiments, some of the functionality described herein as being performed by Patent Licensing Server 110 may instead or in addition be performed by a server of another entity operating on behalf of the Patent Licensing Server 110 (e.g., the patent licensing service which operates Patent Licensing Server 110 may outsource some functionality or otherwise allow some functionality to be performed by servers of other entities, such as registration of new users, analyzing or parsing of text to identify which portions of the text relate to different features of a product, determining a relevancy score for a patent with respect to a particular product, authorization of credit card transactions or otherwise collecting or disbursing payments, etc.).

The Patent Licensing Server 110 may comprise one or more computing devices, working in parallel or series if more than one, operable to facilitate the analysis of a product description or patent, determination of patents relevant to a product, creation of a package of patents for a product, managing a product provider's subscription to or purchase of a patent package or other functions or methodologies described herein. The Patent Licensing Server 110 may be operated by or on behalf of an entity which offers services to facilitate the creation, offering, management, tracking and satisfaction of obligations, duties or rights defined by a patent package, in accordance with embodiments described herein. In accordance with some embodiments, a patent package may comprise a contract or enforceable agreement between the Patent Licensing Service described herein and a product provider, defining rights and obligations which may include, for example, (i) terms of a non-exclusive license granted to the product provider by the Patent Licensing Service (E.g., the Patent Licensing Service may act as a broker which has obtained licensing or sub-licensing rights for various patents from the respective patent owners of the patents); (ii) terms which obligate the Patent Licensing Service to provide certain financial aid to the product provider if one or more predetermined conditions are satisfied with respect to a patent which is included in the patent package but which is not licensed under the terms of the patent package; (iii) one or more service or information benefits the Patent Licensing Service is to provide to the product provider; and (iv) a payment which the product provider agrees to pay to the Patent Licensing Service for the patent package (e.g., a recurring, periodic payment or a one-time fee).

A User Device 120 may comprise a computing device associated with a user (e.g., a patent right owner, patent enforcer or product provider) utilizing the services of the Patent Licensing Server 110. For example, a User Device 120 may comprise a personal computer such as a desktop, laptop or tablet computer, a cellular telephone or a smartphone or other mobile device. The User Device 120 may be operable to transmit data to the Patent Licensing Server (e.g., one or more texts or documents comprising description of a product, data indicative of a patent available for license, etc.) and/or to receive data from the Patent Licensing Server (e.g., an indication of a product for which a patent is to be licensed by being included in a patent package for the product, an indication of a relevancy score, risk category or score, or other information pertaining to a particular patent). It should be noted that whenever information is described as being “transmitted” to a device of system 100 or other systems described herein, it is intended to encompass both a “push” embodiment in which the information is pro-actively pushed or output to the device by another device and a “pull” embodiment in which the device contacts another device in order to query for any updated information or changes in information.

In some embodiments, any of the components 110, 120 and 130 may communicate with one another directly or indirectly, via a wired or wireless medium such as the Internet, LAN, WAN or Ethernet, Token Ring, or via any appropriate communications means or combination of communications means. For example, in one embodiment communication among any and all of the devices of system 100 may occur over the Internet through a Web site maintained by computer on a remote server or over an on-line data network including commercial on-line service providers, bulletin board systems and the like. In some embodiments, communication among any of the components of system 100 may occur over radio signals, cellular networks, cable network, satellite links and the like.

The system 100 may be operable to facilitate communication using known communication protocols. Possible communication protocols that may be useful in the system 100 include, but are not limited to: Ethernet (or IEEE 802.3), ATP, BLUETOOTH, SMPP Protocol (e.g., SMPP Protocol Version 3.4), HTTP, HTTPS, and Transmission Control Protocol/Internet Protocol (TCP/IP). Communications may be encrypted to ensure privacy and prevent fraud in any of a variety of ways well known in the art, some of which are described herein.

It should be understood that any or all of the devices of system 100 may in some embodiments comprise one or more of (i) an input device; (ii) an output device; (iii) an input/output device; or (iv) a combination thereof. An input device, as the term is used herein, may be any device, element or component (or combination thereof) that is capable of receiving an input (e.g., from a user or another device). An input device may communicate with or be part of another device. Some examples of input devices include: a bar-code scanner, a magnetic stripe reader, a computer keyboard or keypad, a button (e.g., mechanical, electromechanical or “soft”, as in a portion of a touch-screen), a handle, a keypad, a touch-screen, a microphone, an infrared sensor, a voice recognition module, a coin or bill acceptor, a sonic ranger, a computer port, a video camera, a motion detector, a digital camera, a network card, a universal serial bus (USB) port, a GPS receiver, a radio frequency identification (RFID) receiver, an RF receiver, a thermometer, a pressure sensor, an infrared port, and a weight scale. An output device may comprise any device, component or element (or a combination thereof) operable to output information from any of the devices described herein. Examples of an output device include, but are not limited to, a display (e.g., in the form of a touch screen), an audio speaker, an infra-red transmitter, a radio transmitter, an electric motor, a dispenser, an infra-red port, a Braille computer monitor, and a coin or bill dispenser. An input/output device may comprise components capable of facilitating both input and output functions. In one example, a touch-sensitive display screen comprises an input/output device (e.g., the device outputs graphics and receives selections from an authorized person).

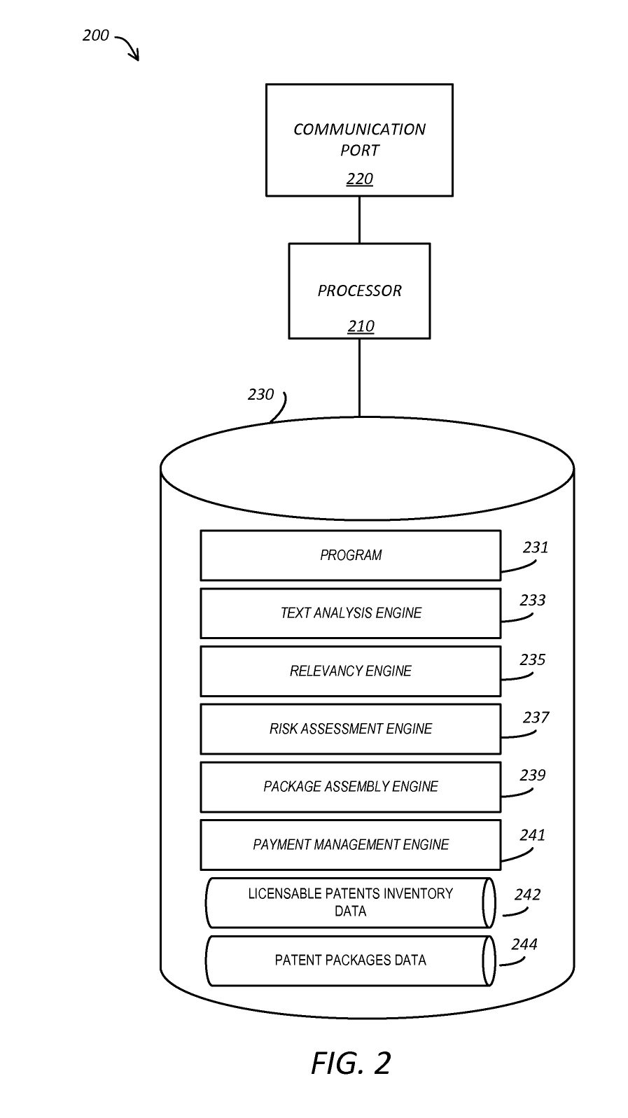

Referring now to FIG. 2, illustrated therein is a block diagram of a Patent Licensing Server 200. The Patent Licensing Server 200 may be implemented as a system controller, a dedicated hardware circuit, an appropriately programmed general-purpose computer, or any other equivalent electronic, mechanical or electro-mechanical device. In accordance with one embodiment, the Patent Licensing Server 200 may comprise the Patent Licensing Server 110 of FIG. 1. The Patent Licensing Server 200 may comprise, for example, one or more server computers operable to communicate with (a) one or more user devices (e.g., device of a patent owner or patent enforcer, which may comprise one or more individuals or a business entity); and/or (b) one or more additional devices (e.g., gateway server, router devices or other devices for facilitating offers for, generation of content or pricing for, or management of, a patent package). The Patent License Server 200 may be operable to facilitate some functions or procedures described herein, such as (i) registering one or more patent owners or patent enforcers who desire to list patents with the system described herein as licensable patents which may be included as licensed patents in the packages described herein, (ii) registering product providers and/or other users; (iii) accessing and/or storing data on one or more patents and/or products; (iv) analyzing texts or documents descriptive of a product to identify one or more features of the product; (v) determining at least one relevancy score for a patent as it pertains to a particular product or feature of the product; (vi) determining a risk score or risk category for a particular patent as it pertains to a particular product or feature of the product; and/or (vii) generating or otherwise determining content or other terms for a patent package (e.g., the one or more patents or claims of patents to be licensed, the royalties due under the license, the term of the license, a portion of the package fee attributable to a particular patent included in the patent package, etc.). The Patent Licensing Server 200, as well as other devices described herein (such as a user device), as well as components thereof, may be implemented in terms of hardware, software or a combination of hardware and software.

The Patent Licensing Server 200 may comprise, for example, one or more server computers operable to communicate with a plurality of computing devices (e.g., respective computing devices of users participating in the patent licensing system described herein) and/or one or more additional devices such as a gateway server, router devices, or other devices for facilitating patent licensing program. For example, Patent Licensing Server 200 may be operable to communicate, via a network (not shown), with one or more computer systems of product providers, patent right owners, servers storing data on one or more patent rights (e.g., whether a server of the patent licensing system described herein or a server of a third party, such as the United States Patent Office (USPTO) and/or a server of one or more financial institutions (e.g., the Patent Licensing Server may be operable to transfer patent licensing fees to a bank of a patent rights owner participating in the patent licensing system described herein). The network(s) via which the Patent Licensing Server 200 may be operable to communicate may comprise, for example, a mobile network such as a cellular, satellite, or pager network, the Internet, a wide area network, another network, or a combination of such networks. For example, in one embodiment, both the Internet and a wireless cellular network may be involved in routing communications and/or transmitting data among two or more devices or components of a patent licensing system as described in various embodiments herein.

A product provider, as the term is used herein unless indicated otherwise, refers to an entity (e.g., a person or business enterprise) which manufactures, designs, places, markets, distributes, sells, offers for sale, leases or otherwise makes available one or more products which may be (or a component or feature of which may be) within the scope of one or more claims of a patent (e.g., a patent of a third party), whether alone or in cooperation with another party. A patent right owner, as the term is used herein unless indicated otherwise, refers to an entity (e.g., a person or business enterprise) which holds one or more licensable rights to a patent (e.g., an assignee or licensor who holds sublicensing rights to one or more claims of a patent). In accordance with some embodiments, a patent right owner may comprise a patent enforcer (e.g., may also have rights to enforce the patent) if one of the patent rights held by the patent right owner is a right to enforce the patent.

In accordance with some embodiments, the patent licensing system operates as a licensing agent which identifies multiple patents or patent claims which are relevant to a product of a product provider by accessing one or more databases of patents and/or patent applications and facilitates a package comprising a patent license (e.g., a license to multiple patents) and/or a contract to provide aid (e.g., in the form of patent infringement insurance or a warranty for one or more patents in the package), for a package price. In accordance with some embodiments, the package price may comprise a monthly payment payable by the product provider in order to obtain and retain the rights defined by the terms of the package (e.g., a license to one or more of the patents and insurance for another one or more of the patents).

The patent licensing system may further operate, in accordance with some embodiments, to collect licensing fees from product providers who have entered into patent licenses via the patent licensing system, and forward an appropriate portion of such patent licensing fees to each patent right owner associated with patent rights licensed in the subject patent license. In accordance with some embodiments, this may comprise collecting the monthly payment, allotting a portion of it to each licensed patent (e.g., based on a relevance score determined for the patent) and forwarding a portion of at least part of that portion to the patent right owner who has agreed to license the patent as part of the package. An entity which operates the Patent Licensing Server 200 (directly or via one or more third parties) or directs the functions described herein as being performed by the Patent Licensing Server 200 is referred to as a Patent Licensing Service herein. It should be understood that a Patent Licensing Server or a Patent Licensing Service are not limited to functions or services only for licensing patents but may also operate to facilitate aid (e.g., insurance or warranties included in a package of patents which also includes a license to some patents) with respect to one or more patents, brokering the sale of one or more patents or providing other functions and services described herein. The operations described herein may be divided across a plurality of computing systems, and are shown to reside in a single processing device of FIG. 2 so as to simplify the description.

The Patent Licensing Server 200 comprises a processor 210, such as one or more INTEL PENTIUM processors. The processor 210 may be operable to utilize or be in communication with one or more communication ports 220. A communication port 220 may comprise a component (which can be embodied as hardware, software and/or firmware) for communicating, directly or indirectly, with one or more other devices. A communication port 220 may be operable to work in various language and protocol environments, as would be understood by one of ordinary skill in the art (e.g., http, TCP/IP, SMPP). A communication port 220 may comprise, for example, an Ethernet port, a PTSN port, a wireless modem, a wireless network card, a SIM card, a USB port or a serial port.

The processor 210 is further in communication with a memory 230. The memory 230 may comprise an appropriate combination of magnetic, optical and/or semiconductor memory, and may include, for example, Random Access Memory (RAM), Read-Only Memory (ROM), a compact disc and/or a hard disk. The processor 210 and the memory 230 may each be, for example: (i) located entirely within a single computer or other device; or (ii) connected to each other by a remote communication medium, such as a serial port cable, telephone line or radio frequency transceiver. In one embodiment, the Patent Licensing Server 200 may comprise one or more devices that are connected to a remote server computer for maintaining databases.

The memory 230 may store (or be operable to access) one or more software module(s) for directing the processor 210 to perform certain functions. In accordance with some embodiments, software components, applications, routines or sub-routines, or sets of instructions for causing one or more processors to perform certain functions may be referred to as “modules” or “engines” herein. It should be noted that such modules or engines, or any software or computer program referred to herein, may be written in any computer language and may be a portion of a monolithic code base, or may be developed in more discrete code portions, such as is typical in object-oriented computer languages. In addition, the modules, engines or any software or computer program referred to herein, may in some embodiments be distributed across a plurality of computer platforms, servers, terminals, and the like. For example, a given engine or module may be implemented such that the described functions are performed by separate processors and/or computing hardware platforms.

With reference to FIG. 2, it should be understood that any of the software engines, modules or computer programs illustrated therein may be part of a single program or integrated into various programs for controlling processor 210. Further, any of the software modules, engines or computer programs illustrated therein may be stored in a compressed, uncompiled, and/or encrypted format and include instructions which, when performed by the processor 210, cause the processor 210 to operate in accordance with at least some of the methods described herein. Of course, additional and/or different software modules, engines or computer programs may be included and it should be understood that the example software modules, engines or computer programs illustrated and described with respect to FIG. 2 are not necessary in any embodiments. Use of the term “module” or “engine’ is not intended to imply that the functionality described with reference thereto is embodied as a stand-alone or independently functioning program or application. While in some embodiments functionality described with respect to a particular module or engine may be independently functioning, in other embodiments such functionality is described with reference to a particular module or engine for ease or convenience of description only and such functionality may in fact be a part of integrated into another module, program, application, or set of instructions for directing a processor of a computing device.

According to an embodiment, the instructions of any or all of the software modules, engines or programs described with respect to FIG. 2 may be read into a main memory from another computer-readable medium, such from a ROM to RAM. Execution of sequences of the instructions in the software modules, engines or programs causes processor 210 to perform at least some of the process steps described herein. In alternate embodiments, hard-wired circuitry may be used in place of, or in combination with, software instructions for implementation of the processes of the embodiments described herein. Thus, the embodiments described herein are not limited to any specific combination of hardware and software. Some example software modules that may be utilized in Patent Licensing Server 200 include, without limitation: (i) a program 231; (ii) a text analysis engine 233 (e.g., for analyzing text descriptive of a product, such as for identifying one or more features of a product or portions of the text(s) which refer to different features of the product); (iii) a relevancy engine 235 (e.g., for determining one or more relevancy scores for a patent or product); (iv) a risk assessment engine 237 (e.g., for determine a risk category or other risk assessment result for a particular patent or product); (v) a package assembly engine 239 (e.g., for generating a list of patents to include in a package and one or more terms defining the package, such as licensing and aid terms); and (iii) a payment management engine 241 (e.g., for tracking and managing the receipt of payments from product providers and/or disbursing licensing payments to patent right owners who have agreed to license their patents in one or more patent packages).

The program 231 may be a general purpose program for directing more general functions of the Patent Licensing Server 200. Each of the engines 233 through 241 may be for performing specialized functions in accordance with one or more embodiments, which are described in more detail below. Of course, additional or different software engines may be included in a patent licensing system consistent with the embodiments described herein. According to an embodiment, the instructions of any or all of the software programs or software engines 231-241 may be read into a main memory from another computer-readable medium, such from a ROM to RAM. Execution of sequences of the instructions in the programs or software engines 231-241 causes processor 210 to perform the process steps described herein.

In accordance with some embodiments, the text analysis engine 233 may comprise software, instructions, sub-routines and/or algorithms for analyzing one or more texts (e.g., in the form of long form textual documents) or documents (e.g., PDF documents, POWERPOINT™ presentations, WORD™ documents, web pages) descriptive of a product. In accordance with some embodiments, such texts or documents may be provided to the Patent Licensing Service by a product provider of the product. In some embodiments, such texts or documents may be obtained by the Patent Licensing Service from other sources (e.g., websites describing the product or otherwise off the Internet or from proprietary databases which store documents or other forms of description for the product). In accordance with some embodiments, a purpose of the text analysis engine is to analyze, parse or review the text in order to identify which parts of the text(s) describe different features of the product (and, in some embodiments, thereby determine the different features of the product) and/or to identify one or more search terms to be used in analyzing or reviewing a plurality of patents in order to identify patents which may be relevant to the product. Such texts or documents which are analyzed (e.g., via the text analysis engine 233) may be referred to as “source texts” herein.

In accordance with sonic embodiments, a methodology for analyzing source texts (e.g., as performed by text analysis engine 21) may comprise (i) analyzing and breaking up source texts to identify features or components which may be useful in determining one or more patents which are useful to the product, and (ii) extracting a volume of descriptive text from the source texts for each identified component or feature (e.g., active noise cancellation may be a component or feature of headphone product). In accordance with some embodiments, such analysis may be done using text tiling (a technique for automatically subdividing texts into multi-paragraph units that represent subtopics addressed in the text). In accordance with some embodiments, a source text may be parsed or categorized into component sub-texts, each component sub-text relevant to a particular component or feature identified in the analysis. In accordance with some embodiments, a search against one or more databases of patents (whether a proprietary database compiled and maintained by the Patent Licensing Service or a publicly available database such as that maintained by the USPTO) may then be performed using the sub-texts or search terms identified in the text analysis to identify one or more patents which my be relevant to the product associated with the source text.

In accordance with some embodiments, a relevancy engine 235 may comprise software, instructions, sub-routines and/or algorithms for determining whether a particular patent (or at least one claim of a particular patent) is relevant to a particular product (or at least one feature or component of the product). In accordance with some embodiments, relevancy may be an indication or determination of whether the product (or the at least one feature of the product) (i) may reasonably be interpreted or is likely to be interpreted to be within the scope of at least one claim of the patent or within the scope of a description in the patent; and/or (ii) describes and/or claims a product or feature which is similar to the product for which the relevancy is being determined. Whether a patent is relevant to a product should not be interpreted as an opinion or determination of whether a claim of the patent is infringed by the product or feature of the product, as various factors relevant to such an opinion or determination may not be taken into account in determining the relevancy of the patent to the product (e.g., prosecution history estoppel, claim term interpretation or construction which may include balancing various proposed interpretations from opposing parties, etc.).

In accordance with one embodiment, determining the relevancy of a patent to a product may comprise determining at least one relevancy score for a particular patent with respect to the product. Methodologies for determining a relevancy score for a patent are described in detail elsewhere herein. In some embodiments, multiple relevancy scores may be determined for a particular patent as it relates to a particular product (e.g., each relevancy score being determined using a respective and different methodology) and a final relevancy score may be generated by combining (e.g., averaging or adding) the various relevancy scores together.

The determination of the relevancy of a patent to a particular product may be done, in one embodiment, on a probabilistic basis (e.g., as opposed the definitive relationship of the patent to a product). In one embodiment, a scheme of filters (which may be referred to as relevancy filters) may be used when analyzing patent data to identify the patent(s) which are relevant to a particular product. For example, one filter may correlate the patent class of USPTO and/or IPC with codes such as the NAICS or the SIC codes. Another example of a relevancy filter may comprise correlating the patent class with another set of text based classification such as the Thomson Reuters™ or GICS™ classification of company. In one embodiment data on a set of patents will be entered into the system which initially need to be analyzed one at a time and each patent will be analyzed against a universe of products (which universe may, in some embodiments, comprise a single particular product per analysis). Each patent entered into the system may, in some embodiments, be analyzed keeping the broadest set of companies or products relevant (e.g., based on a text based analysis and scoring of such relevancy). The patent may then be correlated with specific product(s). In one embodiment, based on the output from the relevancy engine 233, a set of patents will be identified which when constituted together create a package license of patents relevant to a specific product of a product provider. For example, if there are 20,000 patents provided as the initial portfolio entered into the relevancy engine the outcome of analyzing the relevancy of these patents against various products may comprise 50 patent licenses or packages, each patent license package including about 100 patents. It should be noted that, in accordance with some embodiments, the patent license packages generated by the system may not be mutually exclusive to each other (i.e., the same patent may be included in more than one suggested package license for different products).

In some embodiments the product for which relevant patents are being determined may comprise a product for which a package license is affirmatively requested by a product provider of the product. In other embodiments, products thr which packaged licenses are determined may be products identified by the system based on, for example, publicly available information such as Edgar Online™, Websites, presentation and press releases, repositories of company information such as Zoominfo™, repositories of product information, trade association and conference proceedings or any other text based searchable information.

Various approaches have been adopted for achieving text-based relevancy, one or more of which may be utilized by the Patent Licensing Server 200. For example, in one embodiment a Google™ approach to bringing relevancy of web pages to a certain search term or terms may be employed. In another embodiment, the relevancy approach taken by Innography™ using vector analysis of patent language may be employed.

In accordance with some embodiments, the text analysis described herein as being performed by the text analysis engine 233 and the relevancy analysis described herein as being performed by the relevancy engine 235 may be embodies as a single or comprehensive process. For example, in accordance with some embodiments, the Patent Licensing System 200 may be operable to receive (e.g., from a product provider interested in obtaining a patent package fora particular product) one or more documents containing long-form text that describes the product. The system may be operable to parse the uploaded documents or other source texts and segment each source text into sections, each of which describes a “feature” of the product. In accordance with some embodiments, such a segmentation may be performed using a Natural Language Processing (NLP) technique referred to as “text tiling”. In accordance with some embodiments, the source text(s) may be parsed in sequence and a rolling window of terms (i.e. words in the text stemmed to their root representation) may be kept in memory. As the parsing moves forward the window may be advanced by a certain number of terms. The new window of terms may then compared to the previous window of terms to determine similarity using, for example, the cosine between the two term vectors. In some embodiments, when the similarity between the two windows is greater than a certain threshold it is assumed that the next section of the source text is referring to a different “feature” of the product.

In accordance with some embodiments, once the source text(s) are analyzed and parsed into text blocks determined to correspond to respective feature, for each text block (or plurality of text blocks) representing a feature of the product, a semantic search may be performed against one or more databases storing information about patents (e.g., granted U.S. patents or patent applications and/or patents or patent applications in other jurisdictions). In one embodiment, the search may be based on an NLP algorithm called Latent Semantic Analysis, such as that made available INNOGRAPHY™ via an API. The result of this search is a list of patents ranked in order of their relevance to the feature text block. In one embodiment, the ranked lists of patents for each feature may then be merged or compiled together into a single list of patents relevant to the product.

In accordance with one embodiment, each patent on the list of patents determined to be relevant to a product based on a relevancy score as described above may further be subjected to a second relevancy algorithm, which algorithm generates a second ranking of the patents based on a claims-level analysis. For example, in accordance with one embodiment, the independent claims for all of the patents in the list are compared to the original source text(s) (or blocks of texts determined during the parsing analysis described above) using an NLP technique referred to as Latent Dirichlet Allocation. For example, for source text(s) (or blocks of texts determined during the parsing analysis described above), and at least one independent claim in at least one patent on the list of patents determined based on the initial relevancy score, LDA may assign a probability distribution across a set of arbitrary “topics” generated by the algorithm. Relevance of a given patent claim to the source text(s) (or blocks of texts determined during the parsing analysis described above) is then determined mathematically by comparing the LDA topic distribution of the claim to that of the source text(s) (or blocks of texts determined during the parsing analysis described above) using an algorithm called Jensen-Shannon Divergence. The result may comprise a second relevancy score based on this claims analysis. In accordance with some embodiments, additional relevancy scores may be determined for a patent using different methodologies.

In accordance with some embodiments, the multiple relevancy scores determined for each patent on the list of relevant patents, each relevancy score determined via the respective methodologies (e.g., ones as described above), may be combined or utilized to determine a final relevancy score for each patent. For example, the two relevancy scores may be averaged together, added together or otherwise used as values in an equation the result of which is a final relevancy score for each patent on the list of relevant patents. Once a final relevancy score is determined for a patent with respect to a product (whether this is a single score or an amalgamation or result of a plurality of scores). The list of patents may, in some embodiments, be sorted according to the final relevancy scores (e.g., from most relevant to least relevant) and the top most relevant patents (e.g., the top 100 patents or some other predetermined number of patents) may then be selected for inclusion in a patent package for the product. In other embodiments, all patents determined to be relevant may be included in a patent package.

In one embodiment, a quality analysis may be performed (or retrieved from memory) for each patent on the list of relevant patents and any patents a quality of which is determined to be unacceptable (e.g., a quality result is below a minimum threshold) may be removed from the list of patents determined to be relevant to the product for which the patents are being determined or identified. In accordance with some embodiments, methodologies which are additional or different from those described with respect to FIG. 2 (e.g., embodied as software modules or engines stored in memory 230 or in another memory) may be employed by the Patent Licensing Server 200. For example, a quality assessment engine may be utilized in some embodiments to assess the quality of a patent or patent right being analyzed by the system (e.g., to de-select patents which are of low quality or to associate a quality rating with the patent). The quality assessment engine may consider various factors in assessing the quality of a patent or patent rights, such as (i) forward citations; (ii) number of claims; (iii) number of words in a claim (e.g., assuming the more words in a claim, the lower quality the claim); (iv) quality of inventor (e.g., more inventions by an inventor signifies more mature inventor); (v) quality of a law firm named on the patent; (vi) claims to specifications analysis; and/or (vii) the strength of art and technology. In some embodiments, a quality assessment result (e.g., a rating or ranking) may be utilized to at least partially determine a licensing fee or royalty rate or tier for a patent right. In some embodiments, a quality assessment result may comprise or be encompassed within a relevancy determination or score. In some embodiments, a quality assessment result for a patent included in a particular package may be utilized to apportion a part of a package payment (e.g., a part of a monthly subscription fee for a package) to the patent. In some embodiments a quality assessment result of a patent right may be output to users who are considering including the patent right in a patent license package.

In accordance with some embodiments, a risk assessment engine 237 may comprise software, instructions, sub-routines and/or algorithms for determining an indication of a likelihood that a particular patent may be asserted against a particular product (that a patent enforcer associated with the patent will sue the product provider of the product for alleged infringement of the patent by the product). Thus, risk in some embodiments may refer to risk of litigation or enforcement of the patent against the product provider for the product being analyzed. In accordance with some embodiments, performing a risk analysis for a patent may comprise calculating a risk score for the patent. In accordance with some embodiments, performing a risk analysis for a patent (e.g., with respect to a particular product) may comprise determining a risk category for the patent. For example, a scheme comprising a plurality of predetermined risk categories may be utilized (e.g., low, medium and high risk level scheme may be used such that there are 3 possible risk categories). In one embodiment, determining which risk category is to be associated with a patent may be based on an assessment of a variety of factors. Examples of factors on which risk category is determined may factors intrinsic to the patent (e.g., number of claims, length of claims, time to prosecute, etc.) and factors extrinsic to the patent (e.g., identity or category of patent owner (e.g., competitor of the product provider, recognized non practicing entity which regularly enforces its patents), litigation history of patent, litigation history of industry, etc.). Thus, the risk assessment engine 237 may be programmed to identify (e.g., from databases or other sources internal to the system 200 or ones external to it, such as third party databases or publicly available information) data relevant to a determination of a risk of litigation for a patent and using the data in an algorithm to determine a risk result (e.g., a risk score or a risk category) to assign to the patent. It should be understood that the same patent may be determined to have a different risk result (whether it be a risk category, score or other indicator of risk) as it pertains to different products or industries. As described herein, a risk assessment result (e.g., a risk category or risk score) may be used for one or more other processes described herein (e.g., for determining a level of aid to include for a not licensable patent included in a patent package).

In accordance with some embodiments, a package assembly engine 239 may comprise software, instructions, sub-routines and/or algorithms for assembling a package of patent for a particular product. In accordance with some embodiments, assembling the patent package may comprise (i) determining which patents are to be included in the patent package; (ii) determining a payment or price for the patent package (which may, in some embodiments, be a recurring monthly payment); and (iii) determining one or more terms for the contract comprising the patent package (e.g., the parties to the contract being the Patent Licensing Service and the product provider associated with the product for which the patent package is assembled). In accordance with some embodiments, different patents in the patent package may be subject to different terms of the contract. In accordance with some embodiment, the package may comprise patents which are to be licensed (e.g., non-exclusive licenses) to the product provider for one or more particular products. In accordance with some embodiments, the package may further comprise patents which are not licensable (e.g., for patents which are determined to be relevant but for which the Patent Licensing Service does not have licensing rights). With respect to the latter, in lieu of a license, an obligation (e.g., on the part of the Patent Licensing Service) to provide financial aid under certain circumstances may be included in the patent package. For example, the Patent Licensing Service may contract with the product provider that if the patent provider is sued for patent infringement based on a not licensed patent included in the patent package, the Patent Licensing Service will provide financial aid as specified for the patent under the terms of the patent package (e.g., the Patent Licensing Service may pay or reimburse for a certain amount or percentage of the patent provider's legal costs in defending against the patent infringement action).

Thus, in accordance with some embodiments, the package assembly engine 239 may be operable to determine which of the relevant patents identified in different processes of the system 200 are to be included in the patent package. For example, in some embodiments, only up to a maximum number of the most relevant patents are selected for inclusion in the patent package. In another example, in some embodiments patents determined to be associated with too high of a risk of litigation or to be of too low quality may be excluded from a patent package.

In accordance with some embodiments, the package assembly engine 239 may further be operable to determine which patents of the patents determined to be sufficiently relevant to a product are ones for which the Patent Licensing Service has licensing rights for. For example, in one embodiment the Patent Licensing Server 200 may store a database of licensable patents. Licensable patents may comprise patents for which the respective patent right owners (e.g., an owner or assignee of at least a portion of the patent) have provided licensing rights to the Patent Licensing Service). In FIG. 2, the memory 230 is illustrated as storing a licensable patent inventory data 242, which may comprise data on each of the patents the Patent Licensing Service has licensing rights for (it should be understood that licensing rights may include sub-licensing rights).

In accordance with some embodiments, the package assembly engine 239 may be operable to compare list of patents determined to be relevant to a product and to be included in a patent package for the product to an inventory of licensable patents, such as that embodied in the licensable patent inventory data 242. The relevant patents which are determined to be included in the inventory of licensable patents may be included in the patent package being assembled as licensed patents. The relevant patents which are determined to not be included in the inventory of licensable patents may be determined to be not licensed patents for which financial aid terms are to be determined for inclusion in the patent package.

In some embodiments, before a licensable patent is included in a patent package offered to a product provider, the patent right owner of a patent determined to be relevant to a product may be contacted to verify or object to inclusion of the patent in the particular patent package. If the patent right owner does not agree to, or objects to, the inclusion of a patent in the particular patent package, that patent may be considered a not licensed patent with respect to the that particular patent package. In some embodiments, a patent right owner who agrees to allow the Patent Licensing Service to license its patent via one or more patent packages may specify one or more criteria for excluding the patent from patent packages which meet the criteria (referred to as “exclusion criteria” herein). For example, a patent right owner may desire to exclude a patent from patent packages offered to product providers who are competitors of the patent right owner (which the patent right owner may specifically name or which may be identified using other means) or from patent packages offered to product providers who fall within one or more categories e.g., companies which make over a predetermined amount of annual revenue, Fortune 500 companies, companies in certain industries, etc.). In some embodiments, a patent determined to be relevant, a licensable patent hut which is to be excluded from a particular patent package because certain exclusion criteria for the patent are determined to be triggered may be considered a not licensed patent for the particular patent package. In some embodiments, package assembly engine 239 may be operable to determine, for a patent determined to be sufficiently relevant to a product such that it is to be included in a patent package for the product, whether the inclusion of the patent as a licensed patent would violate one or more exclusion criteria associated with the patent and, if it does, categorize the patent as a not licensed patent for the patent package.

In accordance with some embodiments, one or more terms for provision of financial aid with respect to a relevant patent may be determined based on a risk assessment result, such as a risk score or a risk category. For example, in accordance with one embodiment, different financial aid terms may correspond to different risk categories (e.g., the financial aid for a patent in a low risk category may be a 50% co-pay on legal costs up to $100K while the financial aid for a patent in a high risk category may be a 10% co-pay on legal costs up to $50K). Accordingly, the package assembly engine 239 may be operable to determine the financial aid terms for each not licensed patent to be included in a given package based on the risk assessment result (e.g., the risk category) determined for that patent relative to the product for which the patent package is being assembled.

In accordance with some embodiments, a patent package may include one or more service or information benefits to be provided to the product provider. For example, the Patent Licensing Service may offer a competitive landscape analysis (e.g., of patent assets filed by competitors of the product provider), updates on newly granted patents or newly published patent applications (e.g., relevant to products of the product provider, based on key words provided by the product provider, in certain classes selected by the product provider, etc.), patentability searches or clearance searches. In some embodiments, assembling a patent package may comprise selecting one or more of such service or information benefits to be provided to the product provider (or a budget which the product provider may spend with the Patent Licensing Service on such services or information). In some embodiments, a choice of such service or information benefits may be output to the product provider and a selection of one or more such service or information benefits may be received from the product provider, for inclusion in the patent package (e.g., the product provider may be allowed to select a predetermined number of service or information benefits from a menu of available service or information benefits).

In accordance with some embodiments, the Patent Licensing Service may offer different types or categories of patent packages. For example, a first type of patent package offered at a first price point may include only licensed patents, a second type of patent package offered at a second price point may include both licensed patents and not licensed patents for which financial aid is offered and a third type of patent package offered at a third price point may include licensed patents, not licensed patents and additional service or information benefits. In another example, a first type of patent package at a first price point may include a first maximum number of patents white a second type of patent package at a second price point may include a second maximum number of patents. Accordingly, the package assembly engine 239 may comprise determining the appropriate content for a patent package based on the type of patent package is being assembled.

In accordance with some embodiments, a payment management engine 241 may comprise software, instructions, sub-routines and/or algorithms for managing or facilitating payments for patent packages. Such payments may comprise payments collected from product providers and/or payments disbursed to patent right owners (e.g., royalty or other payments thr licensed patents included in patent packages). For example, the payment management engine 241 may track, for each patent in the inventory of licensable patents, the royalties collected (or billed) for the patent based on its inclusion in different patent packages and (e.g., on a periodic basis) provide the total of such royalties to the patent right owner of the patent (or its designee). In another example, the payment management engine 241 may manage and facilitate the collection of payments (e.g., on a monthly or other basis) from product providers who have purchase, licensed or otherwise agreed to pay for at least one patent package.

In accordance with some embodiments, the payment management engine 241 may be operable to determine a price to charge a product provider for a particular patent package. For example, such a price may be determined based on the patents included in the patent package (e.g., in some embodiments, different royalty terms may be agreed upon with different patent right owners such that a patent package price may be based on the royalties due to the respective patent right owners for the licensed patents). In some embodiments, a price for a patent package may be based at least in part on a risk assessment result and/or a relevancy score for the respective patents in the package. In other embodiments, the price may be determined independently of the particular patents included in the patent package (e.g., a predetermined price per package or per certain level or category of packages may be charged for all patent packages or all patent packages of the particular level or category).

In accordance with some embodiments, the revenue received from a product provider (e.g., the monthly subscription price) for a patent package may be allocated as follows: (i) a a first portion (e.g., predetermined percentage, such as 10%) is attributed to the services or information benefits included in the patent package; (ii) from the remaining revenue, a second portion (e.g., predetermined percentage, such as 20%) is retained by the Patent Licensing Service as a commission; and (iii) the revenue remaining after the first and second portions have been removed is allocated or apportioned among the patents included in the package based on the final relevancy score of each patent (e.g., a dollar amount is calculated for each patent as the allocated portion of the remaining revenue). In one embodiment, for a licensed patent, the allocated portion (e.g., as embodied in a particular dollar amount determined for the patent) of the revenue may be forwarded to the patent right owner or its designee. For a not licensed patent, the allocated portion (e.g., as embodied in a particular dollar amount determined for the patent) may be put toward the financial aid for that patent.

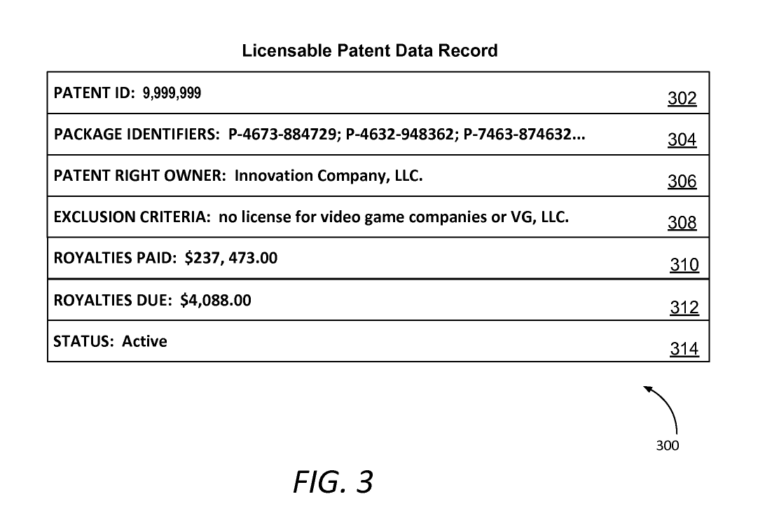

In accordance with some embodiments, the memory 230 may further store Licensable Patents Inventory Data 242, which comprises information about patent rights licensable by the Patent Licensing Server 200. Such information may comprise data on one or more patents which are, or at some point were, licensable by the Patent Licensing Service by being included in one or more patent packages. An example record of the Licensable Patents Inventory Data 242, consistent with some embodiments, is illustrated in FIG. 3.

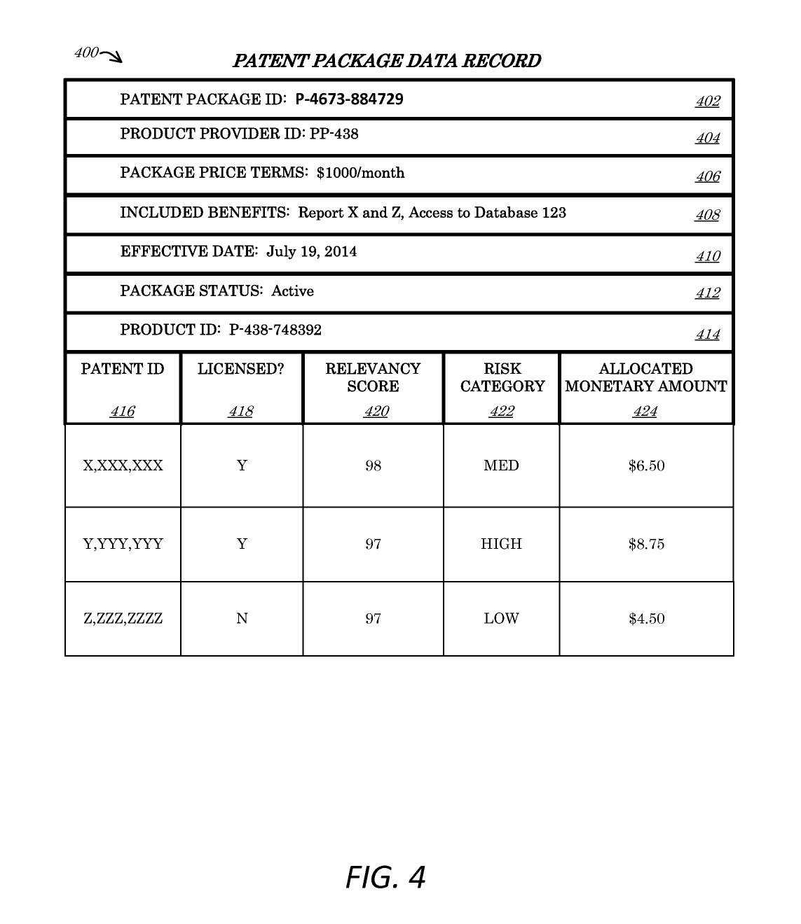

In accordance with some embodiments, the memory 230 may further store Patent Packages Data 242, which comprises information about one or more patent packages assembled by the Patent Licensing Server 200. Such information may comprise, for each such patent package, data indicating the content of the patent package (e.g., patents included in the package and/or service or information benefits included in the package) and/or one or more terms of a contract comprising the patent package (e.g., payment terms for how much and when payment is due for the package and/or aid to be provided to the product provider for one or more of the patents if a predetermined condition is satisfied). An example record of the Patent Package Data 244, consistent with some embodiments, is illustrated in FIG. 4.

Of course, additional or different information may be stored in system 200, for use in various embodiments. For example, in one embodiment the memory 230 may store data or information about products for which a patent package may be assembled (e.g., products of product providers who participate in the services offered by the Patent Licensing Service). Such information may include, for example and for each respective product, (i) information identifying the product (e.g., a UPC code for a tangible product); (ii) an indication of a process or functionality of the product; (iii) an indication of one or more components of the product; (iv) contact information for the product provider; (v) one or more documents describing the product; and/or (vi) an indication of any patent licenses associated with the product.

Although the data/databases 242 and 244 are described as being stored in a memory of Patent Licensing Server 200, in other embodiments some or all of these databases (or data stored therein) may be partially or wholly stored, in lieu of or in addition to being stored in a memory of Patent Licensing Server 200, in a memory of one or more other devices. Such one or more other devices may comprise, for example, another computing device with which Patent Licensing Server 200 is operable to communicate. Further, some or all of the data described as being stored in the memory 230 may be partially or wholly stored (in addition to or in lieu of being stored in the memory 230) in a memory of one or more other devices. Such one or more other devices may comprise, for example, a remote storage service server (e.g., an online back-up storage server, as would be understood by one of ordinary skill in the art) or a third party server with which the Patent Licensing Server 200 is programmed to cooperate or communicate to perform at least some of the functions or processes described herein.

In some embodiments, additional devices or components that are not show in FIG. 2 may be part of a system for facilitating a patent licensing program as described herein. For example, one or more servers operable to serve as wireless network gateways or routers may be part of such a system. In other embodiments, some of the functionality described herein as being performed by Patent Licensing Server 200 may instead or in addition be performed by a third party server operating on behalf of an entity operating Patent Licensing Server 200 (e.g., the entity operating the Patent Licensing Server 200 may outsource some functionality, such as registration of patent right owners and product providers, collecting and/or transmitting licensing fees and/or analyzing the quality, relevancy, risk or other characteristic or indicator of a patent). Thus, a third party server may be a part of a system which includes Patent Licensing Server 200 and such third party server may or may not be operated by the same entity which operates Patent Licensing Server 200. It should be understood that any of the functionality described herein as being performed by the Patent Licensing Server 200 may in some embodiments be performed by such third party server. For example, one or more of the functions or processes described herein as being performed by Patent Licensing Server 200 or a component thereof (e.g., an engine, module or software application of Patent Licensing Server 200) may be implemented with the use of one or more cloud-based servers which, in one embodiment, may be operated by or with the help of a third party distinct from the entity which operates the Patent Licensing Server 200, such as in a cloud-computing environment, for example.

Turning now to FIGS. 3 and 4, each of these figures illustrates a respective table, each table comprising an example structure and sample contents of a database or portion of a database (e.g., a record of a database) that may be useful in some embodiments. In particular, the example tables represented in any of FIGS. 3 and 4 may be useful in facilitating the assembly and management of a patent package by the Patent Licensing Server. In accordance with some embodiments, table 300 illustrated in FIG. 3 may comprise an example of a record of the Licensable Patent Inventory Data 242 (FIG. 2) and table 400 in FIG. 4 may comprise an example of a record of Patent Package Data 242 (FIG. 2).

The data and fields of the tables 300 and 400 can be readily modified, for example, to include more or fewer data fields. A single database or table that is a combination of multiple databases or tables, or a configuration that utilizes multiple databases or table for a single database or table illustrated herein may also be employed. In the databases of FIG. 3 and FIG. 4, a different reference numeral is employed to identify each field. However, in at least one embodiment, fields that are similarly named (e.g., a patent identifier) may store similar or the same data in a similar or in the same data format.

As will be understood by those skilled in the art, the schematic illustration and accompanying descriptions of data contained in the sample tables presented herein is an exemplary arrangement for stored representations of information. Any number of other arrangements may be employed besides those suggested by the tables shown. For example, the embodiments described herein could be practiced effectively using more or fewer functionally equivalent databases or tables. Similarly, the illustrated entries of the databases or tables represent exemplary information only; those skilled in the art will understand that the number and content of the entries can be different from those illustrated herein. Further, despite the depiction of the databases as tables, an object-based model could be used to store and manipulate the data types of one or more embodiments and likewise, object methods or behaviors can be used to implement the processes of one or more embodiments.

Turning now to FIG. 3, illustrated therein is a table 300, defining information for a patent which may be available for licensing in one or more patent packages by the Patent Licensing Service described herein. The information in a record such as that illustrated in table 300 may be received, determined, generated and/or stored, for example, when a patent rights owner (e.g., a patent owner or assignee) agrees to list a patent with the Patent Licensing Service described herein, thus making it available for being included as a licensed patent in a patent package (e.g., subject to the patent right's owner agreement or lack of objection, or subject to one or more exclusion criteria, in accordance with some embodiments).

The record 300 comprises a plurality of fields, each field storing data associated with a particular patent. In particular, the record 300 comprises (i) a patent identifier field 302, which stores at least one identifier for uniquely identifying the patent (e.g., a patent number, a patent publication number and/or a unique identifier generated for the patent by the system 200); (ii) a package identifiers field 304, which stores a unique identifier for each patent package in which the patent has been included; (iii) a patent right owner field 306, which stores information about the patent right owner who provided to the Patent Licensing Server the right to license the patent (e.g., a name, address, contact information and/or unique identifier for the patent right owner); (iv) exclusion criteria field 308, which stores an indication of one or more exclusion criteria (which, in accordance with some embodiments, define circumstances under which the patent is to not be included in a patent package, such as an identity or description of a product provider or type of product provider to which the patent is not to be licensed); (v) a royalties paid field 310, which stores an indication of the sum of royalties paid to the patent right owner for licensing of the patent by the Patent Licensing Service (e.g., to date, within a predetermined period of time such as within the past year, etc.); (vi) a royalties due field 312, which stores an indication of an amount of royalties owed to the patent right owner by the Patent Licensing Service since the last payment of royalties to the patent right owner (e.g., based on revenue collected from product providers who have purchased patent packages in which the patent is included as a licensed patent); and (vii) a status field 314, which stores an indication of a status of the patent. With respect to field 314, the status may be an indication of the patent's current legal status (e.g., whether it has expired, lapsed for failure to pay maintenance fees or is a properly maintained patent whose term still has not expired) or an indication of the status of the patent within the Patent Licensing Service system. For example, in some embodiments a patent right owner may be allowed to remove a patent from the inventory of licensable patents of the Patent Licensing Service (e.g., but the licenses granted to product providers for the patent may remain effective for the term of the contracts comprising the patent packages in which the patent has been included as a licensed patent). In such a circumstance, the status may indicate that the patent is “active” if it is still licensable and “inactive” if it is no longer licensable for whatever reason. OF course, different or additional information may be stored in a record such as record 300. For example, wire transfer instructions or other instructions for providing payment of royalties collected by the Patent Licensing Server to the patent right owner may be stored.

The information in a record such as record 300 may be used by the Patent Licensing Server 200, for example, to determine whether a patent determined to be relevant to a particular product is a licensable patent. Such a determination may be based at least in part, for example, on whether the patent is included in the Licensable Patents Inventory Data, its status is active and it would not be a violation of any exclusion criteria associated with the patent to include the patent as a licensed patent in a patent package for the product. In another example, information in a record such as record 300 may be utilized to contact a patent right owner (e.g., to allow the patent right owner an opportunity to object to the patent being included in a patent package for a particular product). In yet another example, the information may be used to track royalties paid or accrued for the patent. For example, in one embodiment the royalties accrued or collected for the patent may be determined (e.g., on a periodic basis or as new royalty data becomes available), based on the package identifiers listed in field 304, which may be used to facilitate the accrual of royalties by using the package identifiers to access the appropriate records of the patent packages database (e.g., such as is illustrated in FIG. 4) to determine the appropriate dollar amounts collected or due for the patent per patent package).

Turning now to FIG. 4, illustrated therein illustrated therein is a table 400, defining information for a patent package which may be assembled and provided (e.g., sold) to a product provider by the Patent Licensing Service described herein. The table 400 may comprise, for example, a record of the Patent Packages Data 244 (FIG. 2) and may store information about patent license packages generated, offered, facilitated, completed and/or managed by the Patent Licensing Server 200. The information in a record such as that illustrated in table 400 may be received, determined, generated and/or stored, for example, when a patent package is assembled by the Patent Licensing Server 200.

The record 400 comprises a plurality of fields, each field storing data associated with a particular patent. In particular, the record 400 comprises (i) a patent package identifier field 402, which stores an identifier that uniquely identifies the patent package to the Patent Licensing Server 200; (ii) a product provider identifier field 404, which stores a unique identifier for the product provider associated with the package (e.g., the product provider who has purchased or otherwise entered into a contract comprising the patent package with the Patent Licensing Service); (iii) a package price terms field 406, which stores the one or more financial terms to which the product provider agreed in exchange for receiving the benefits of the patent package (e.g., a monthly or other periodic subscription fee, a one-time license fee or purchase price, etc.); (iv) an included benefits field 408, which includes an indication of the one or more service or information benefits included in the package (e.g., reports of certain data, such as competitive patent landscape reports, newly published patent application reports, etc.); (v) an effective date field 410 which stores an effective date for the patent package; (vi) a package status field 412, which stores a status indication for the patent package (e.g., it the patent package active, lapsed for failure to pay a fee, terminated for another reason, etc.); and a product identifier field 414, which stores a unique identifier for the product for which the patent package has been generated (e.g., in accordance with some embodiments, the licenses and aid defined in a patent package are specific to one or more particular products of a product provider, as defined in the patent package).

The record 400 additionally stores data defining each patent included in the patent package. For example, the additional fields 416-424 may store data for each patent for which a non-exclusive license is given and each patent which is a not licensed patent but for which financial aid is to be provided if at least one predetermined condition is satisfied (e.g., the product provider has not breached the contract comprising the patent package and an infringement action is initiated against the product provider based on the patent). In particular, the record 400 further comprises: (i) a patent identifier field 416, which stores a unique identifier for a patent included in the patent package; (ii) a licensed? field 418, which indicates whether the patent is considered a licensed patent or a not licensed patent with respect to the subject patent package; (iii) a relevancy score field 420, which stores at least one relevancy score (e.g., a final relevancy score, which is a combination of a plurality of relevancy scores determined according to respective methodologies) for the patent as it was determined for the product which is the subject of the patent package; (iv) a risk category field 422, which stores an indication of a risk category determined for the patent (or other result of a risk assessment, such as a risk score); and (v) an allocated monetary amount field 424, which stores an indication of a dollar amount allocated to the patent out of the price or other financial term of the patent package (e.g., as determined based on a relevancy score of the patent). In accordance with some embodiments, for a patent which is indicated as a licensed patent in field 418, the value stored in the allocated monetary amount field 424 may comprise a royalty amount for the patent (e.g., which is a portion of the patent package price or other fee paid by the product provider for the patent package) which is to be forwarded to the patent right owner associated with the patent (e.g., which may be determined based on information in the licensable patent inventory data, such as illustrated in record 300 of FIG. 3). Although data for only 3 patents is illustrated in record 400, it should be understood that a patent package may include a much larger number of patents (e.g., 100 or 1000 patents) and a small number of patents is illustrated only for brevity.

In accordance with some embodiments, information stored in a record such as record 400 may be used by the Patent Licensing Server 200 or another device to (i) manage the collection of patent package fees (e.g., such as a monthly subscription fee); (ii) update an amount of royalties due a patent right owner for a particular patent; (iii) determine at least one financial aid term or condition associated with a particular patent in the patent package (e.g., based on the risk category stored in field 422); and (iv) bill a product provider for a price or other fee of the patent package (e.g., based on the data stored in field 406).

Of course, a record such as record 400 may store data which is different or in addition to the data illustrated in FIG. 4. For example, in some embodiments, a record of the Patent Packages Data (or another database or memory mechanism) may further store information about the status of royalties or other patent package fees collected from (or due from) product providers and/or transmitted to patent right owners under a given patent package.

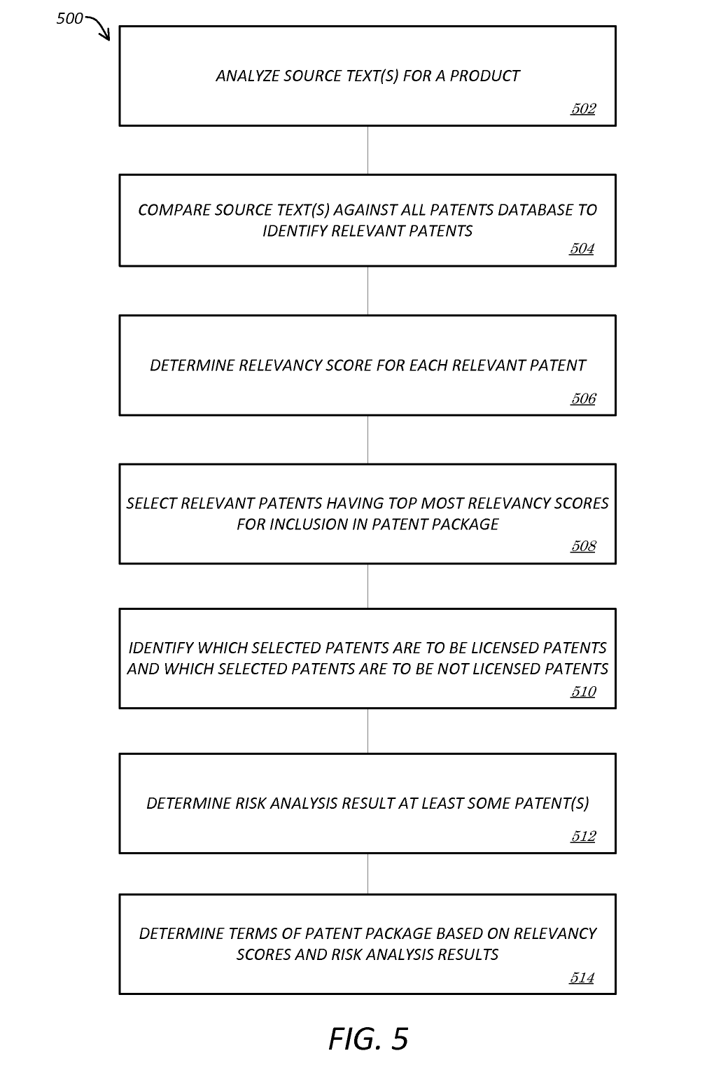

Turning now to FIG. 5, illustrated therein is a flowchart of an example process 500, which is consistent with at least one embodiment described herein. Process 500 (and all processes described herein) is exemplary only and should not be construed in a limiting fashion. For example, additional and/or substitute steps to those illustrated may be practiced within the scope of the present invention(s), in one or more embodiments one or more steps may be omitted or modified and, where practicable, steps may be performed in an order different from what is described.

In one embodiment, process 500 may be performed, for example, by Patent Licensing Server 200. Process 500 comprises on example for generating or assembling a patent package, including determining the content thereof, for a particular product.

It should be noted that whenever information is described as being “transmitted” to the Patent Licensing Server 200 (or any other system or device described herein), it is intended to encompass both a “push” embodiment in which the information is pro-actively pushed or output to the receiving device by another device and a “pull” embodiment in which the receiving device contacts another device in order to query for any updated information or changes in information.

It should be noted that process 500 may be preceded by a registration process (not shown) in which a user (e.g., a product provider and/or patent right owner) registers with Patent Licensing Server 200. During such a registration process, a user may provide one or more preferences for (i) contact information for the user; (ii) preferences of the user; (iii) financial account information of the user (e.g., account identifiers or other credentialing information that may facilitate debiting or depositing of license fees); and/or (iv) login credentials such as a username and password via which the user may subsequently log in to a site of the Patent Licensing Server 200.

In accordance with some embodiments, process 500 may be initiated once a product provider provides information descriptive of a product the product provider would like to purchase a patent package for. For example, the product provider may input a description of the product via one or more interfaces of a website managed or controlled by the Patent Licensing Server. In another example, the product provider may provide a description by uploading or otherwise providing one or more documents or links thereto (e.g., Word™ documents, GOOGLE™ docs documents, PDF™ documents, marketing brochures, websites, etc.) which include description of the product. In accordance with one embodiment, the description provided by the product provider may include particular emphasis on one or more features or components of the product which the product provider is particular interested in having the patent package address in terms of relevant patents. In some embodiments, the Patent Licensing Server 200 may be operable to determine a description of a product not only from a product description provided by the product provider of the product, but also to also identify or obtain a description of the product from other sources (e.g., from publicly available websites or databases or from proprietary databases to which the Patent Licensing Server has access). In some embodiments, personnel of the Patent Licensing Service may analyze the product to determine one or more features, components or processes of the product and input their own description of the product based on such analysis. The documents or other texts comprising description of the product are referred to as source texts of the product herein.

As described herein, while in some embodiments process 500 or other determinations of patents and/or patent packages relevant to a product may be initiated at the request of the product provider of the product, in other embodiments process 500 or such determinations may be performed without a preceding request from the product provider. For example, the Patent Licensing Service may put together a patent package for a product using at least some of the methodologies described herein and contact the product provider with an offer for the patent package without having first received a request for a patent package for the product from the product provider. In such a scenario, the source texts for the product may be determined (at least initially) from publicly available information (even if such information resides in proprietary database or from proprietary services) rather than from descriptions received from the product provider.

Irrespective of whether source texts for a product were received from a product provider or otherwise obtained, and irrespective of whether analysis thereof was initiated in response to a request from a product provider of a product, in step 502 the source text(s) corresponding to a product are analyzed. Such analysis may be performed for purposes of identifying, extracting, generating or otherwise determining information which may be useful in identifying one or more patents which may be relevant to the product. In one embodiment, such text analysis may comprise a step of analyzing the source text(s) to identify one or more features of the product such that patents relevant to the feature(s) may be identified. In another embodiment, such a step of parsing or breaking down the text based on features may not be preferred.

Analyzing the source text(s) corresponding to a particular product may comprise, in one embodiment, parsing the text(s) into sub-texts using a technique such as text tiling. In another embodiment, analyzing the source text(s) may comprise extracting or otherwise determining one or more key words or terms which may then be used to identify one or more relevant patents. In one embodiment, a product provider may even provide one or more key words or terms useful for identifying patent(s) relevant to the product.

In step 504, the source text(s) and/or the results of the analysis (e.g., the sub-texts determined based on the analysis, corresponding to different features of the product) may be compared to a database or other data set of patents in order to identify one or more patents relevant to the product. In accordance with one embodiment, such a database or other data set may comprise any or all of (i) all granted patents in one or more jurisdictions (e.g., all U.S. granted patents); (ii) all published patent applications in one or more jurisdictions; (iii) only patents for which the Patent Licensing Server has licensing rights for. It should be noted that, in accordance with some embodiments, step 504 is performed to identify relevant patents irrespective of whether they are licensable patents (the identified set of relevant patents may subsequently be categorized into licensable and not licensable patents, as described herein) because a patent package may include both licensable and not licensable patents. However, in other embodiments a patent package may only include licensable patents in which case a database of only licensable patents may be searched in step 504.

In accordance with one embodiment, step 504 may comprise a semantic search performed against the desired or preferred data set of patents. For example, a search based on an NLP algorithm called Latent Semantic Analysis, provided by Innography™ via an API may be performed (e.g., by the Patent Licensing Server 200 using an API or by a third party contracted to do so). In accordance with one embodiment, such a semantic search may be performed for each text block representing a feature (as identified in step 502) while in other embodiments such a semantic search may be performed for the entire source text without it having first been parsed into text blocks. In other embodiments, step 504 may comprise searching the desired data set of patents using the key words or terms identified in step 502.

In step 506, a relevancy score (or other indicator of relevancy) is determined (e.g., for each patent determined to be relevant to the product based on the search of step 504). It should be noted that in some embodiments step 506 may be combined with step 504, such that a relevancy score for a patent is determined during the step of identifying relevant patents. For example, a relevancy score or other indicator of relevancy may be determined for each patent in the patent data set using the source text(s) and the patents having a relevancy score above a predetermined threshold, within a predetermined range, or the top-most ranked (e.g., the top 100 or the top scoring 1000 patents) are determined to be relevant to the product.

In some embodiments the determination of relevancy may be binary (e.g., a patent rights is either determined to be relevant to a product or it isn't). In other embodiments relevancy may be determined on a relative scale. For example, a relevancy score, degree, rating or other indicator of relevancy may be determined for each patent determined to be relevant in step 504. Examples of techniques for determining a relevancy score, any of which may be utilized in step 504, are described elsewhere herein (e.g., at least with respect to the relevancy engine 235 of FIG. 2) and need not be repeated herein.

In accordance with some embodiments, as described with respect to relevancy engine 235, a plurality (e.g., two) of relevancy scores may be determined for a given patent (E.g., a patent determined in step 504 to be relevant to the product) and the plurality of relevancy scores may be combined (e.g., averaged) into a final relevancy score utilized for the patent in determining one or more terms of the patent package being assembled for the product. For example, a first relevancy score may be determined using the specification and prosecution history of the patent and a second relevancy score may be determined using a claims-level analysis.

In step 508, the top most relevant patents (e.g., the patents having the top most relevancy scores) are selected for inclusion in a patent package. In some embodiments, step 508 may comprise selecting a predetermined number of patents (e.g., for the package being assembled it may be pre-determined that a certain maximum and/or certain minimum number of patents are to be selected, those being the ones with the highest relative relevancy scores of the patents identified in step 504). In other embodiments, all patents having a relevancy score above a predetermined level are selected, irrespective of how many patents are selected. In yet other embodiments, it may be a combination of the foregoing guiding principles or factors (e.g., only patents having a relevancy score above a predetermined level are selected but not more than a predetermined maximum number are selected). The patents selected for inclusion in the patent package in step 508 may be referred to as the selected patents. It should be noted that, in some embodiments, the selected patents may be further refined in another part of process 500 or via another process (e.g., one or more of the selected patents may be removed from the set of selected patents based on one or more preferences or factors considered by the Patent Licensing System 200).

It is then determined, in step 510, which of the selected patents are to be categorized as licensed patents in the patent package being assembled, and which are to be categorized as not licensed patents. For example, as described with respect to FIG. 2, in accordance with some embodiments any patent which is included as an active patent in an inventory or database of licensable patents may be included in a patent package as a licensed patent (e.g., the Patent Licensing Server may grant to the product provider a non-exclusive license to the patent as part of the patent package). In other embodiments, however, even if a patent is included as an active licensable patent in an inventory or database of patents for which the Patent Licensing Server has licensing rights, the patent may not be considered a licensed patent if (i) the patent right owner of the patent objects to or opts out of having the patent included in the patent package, in response to an opportunity to do so which is output to the patent right owner as a message (e.g., an e-mail or text message) by the Patent Licensing Server during the assembly of the patent package; or (ii) an exclusion criteria associated with the patent renders the patent a not licensed patent with respect to the patent package being assembled (e.g., the product provider is an entity for which the exclusion criteria precludes a license for). Thus, step 510 may comprise determining (i) whether a given patent of the selected patents is a licensable patent; and if it is, further determining whether the patent may be licensed to the product provider in the patent package being assembled based on a response (or lack of response, if the message output to the patent right owner is an opportunity to object which will be considered to be waived if it is not responded to within a predetermined period of time) of a patent right owner and/or an exclusion right associated with the patent. Any patent which is not a licensable patent may, in accordance with some embodiments, be considered a not licensed patent for the patent package.

In step 512, a risk assessment result is determined. In accordance with some embodiments, the risk assessment may be performed (and a result determined) for only the selected patents determined to be not licensed patents (since risk may comprise a risk of litigation). In other embodiments (e.g., in embodiments in which risk analysis results may be useful for purposes in addition to determining risk of litigation), a risk assessment result may be determined for each selected patent. Various techniques and methodologies for performing a risk assessment and determining a corresponding result are described elsewhere herein (e.g., at least with respect to the risk assessment engine 237 of FIG. 2) and need not be repeated herein.

In step 514, the terms of the patent package are determined based at least on the relevancy scores (or other indicators of relevancy) for the selected patents and the risk assessment results determined in step 512. Such terms may comprise, for example, at least one of: (i) the particular patents to be included in the patent package; (ii) the patent package price or other fee to be paid by the product provider in exchange for the patent package; (iii) additional content (e.g., information or service benefits) to be included in the patent package; (iv) an effective and/or termination date or conditions for the patent package; (v) for any not licensed patents included in the patent package, the one or more financial aid terms (e.g., how much and/or up to what maximum amount of the product provider's legal costs will be reimbursed by the Patent Licensing Service if an infringement action is initiated against the product provider based on the corresponding patent); and (vi) for the licensed patents, the royalty or monetary allocation per patent.

In accordance with some embodiments, each package assembled (or each patent package of a certain type, in embodiments where different types of patent packages are available) may correspond to a predetermined price or fee (e.g., a $1,000/month subscription fee). In such embodiments, process 500 may not require a calculation of a price or fee for the package since the price is predetermined. However, in such embodiments the process may still comprise determining an allocation of the predetermined price or fee among various entities (e.g., the Patent Licensing Server, third parties which provide service benefits included in the package and patent right owners of patents included in the patent package) and among the patents included in the patent package. As described with respect to the payment management engine 241 of FIG. 2 and elsewhere herein, in one embodiment a monetary allocation of the package price or fee for a particular patent within the package of fee may be based on a relevancy score of the patent. Thus, in such embodiments, the royalty rate or payment amount a patent right owner receives for a given patent may vary from one patent package to another since the relevancy score for the patent may vary from one patent package to another (e.g., the patent may be more relevant to a first product which is the subject of a first patent package than it is to a second product which is the subject of a second patent package).

In embodiments in which a royalty for a patent is calculated dynamically per patent package based on a price of the package, the number of patents in the package and a relevancy score (or other indicator of relevancy) of each patent, a licensed patent which is determined to be more relevant to the product which is the subject of the patent package will be allocated a larger portion of the predetermined price or fee charged to the product provider for the package than will a patent which is determined to be less relevant. However, because there is a predetermined price for the patent package (or patent packages of a first type) which does not vary based on the particular patents included in the patent package, a patent which is very relevant to a first product of a first patent package may still be allocated a smaller monetary amount from the package price for the first patent package than the monetary amount which may be allocated to it for a second patent package even if that patent is less relevant to a second product which is the subject of the second patent package (e.g., because the second package includes fewer patents so there is more of the package price to be divided among fewer patents or because the second patent package includes fewer very relevant patents which would otherwise garner a significant portion of the patent package price).

For patents which are not licensed patents in a package, the monetary amount or portion of the package price which is allocated to the patent may be considered a premium paid for the future financial aid services which may be provided for the patent if certain conditions are satisfied (e.g., if an infringement action is initiated against the product provider based on the not licensed patent while the patent package is still in force). Various methodologies for allocating a monetary amount to a patent included in a patent package are described elsewhere herein (e.g., at least with respect to the payment management engine of FIG. 2) and need not be repeated herein.

In other embodiments, process 500 may comprise calculating a patent package price or fee based at least on a predetermined royalty amount per patent the Patent Licensing Service has agreed to pay to the appropriate patent right owners, such that the patent package price may vary based on the particular licensed patents included in the patent package. For example, in one embodiment a patent right owner may agree to receive a predetermined royalty for a given patent if the patent is included in a patent package. In yet another embodiment, the patent right owner may agree to receive one of a plurality of royalties for the patent and the royalty which is applied in a given patent package may depend on how relevant the patent is to the product which is the subject of the patent package (e.g., royalty rate A applies if the relevancy score for the patent is within a first range, royalty rate B applies if the relevancy score is within a second range and royalty rate C applies if the relevancy score is within a third range). Thus, in some embodiments, a patent right owner may have pre-established one or more license fees, license fee ranges and/or license fee thresholds or parameters used to determine the patent package price or fee for any patent package in which the patent right's owners patent rights are included. In some embodiments, patents which are determined to be more relevant to a particular product will account for more of the fee of the package than will a patent determined to be less relevant. In some embodiments, determining the patent package price may comprise determining the royalty fee associated with each licensed patent in a database.

A package price or fee may be a one-time payment due when the patent package is accepted by the product provider. In other embodiments, the patent package price or fee may be a recurring, periodic amount (e.g., an annual, quarterly or other periodic fee), such that the patent package is active or in effect so long as the product provider is current with payment of the recurring, periodic amount.

Once the one or more terms of a patent package are determined and the patent package is assembled, process 500 (or a different process) may further comprise outputting an offer for the patent package to the product provider of the product for which the patent package has been determined. For example, an offer identifying the one or more terms of the patent package may be e-mailed to the product provider, mailed to the product provider via postal mail or output to the product provider via an online interface. In accordance with some embodiments, the offer may also specify other terms of the license, such as the grant (e.g., whether the patent is exclusive or non-exclusive, other encumbrances or licenses the relevant patents are subject to, the term of the license, expiration dates for the patent rights included in the license, the jurisdictions in which the license is valid, etc.). In some embodiments, the offer may include one or more choices, each of which may be associated with a distinct patent package price (e.g., the offer may specify a first price for a 5 year patent package term and another price for a patent package term which only expires when the last patent right of the patent package expires).

In accordance with some embodiments, if the product provider accepts the patent package the term of the patent package begins and the Patent Licensing Service begins to manage the collection and disbursement of payments associated with the patent package. For example, going forward, the Patent Licensing Service may collect the appropriate patent package fee from the product provider and transmit, to each respective patent right owner of a licensed patent included in the patent package, the appropriate portion of the patent package price due the patent right owner.

It should be noted that although the patent packages described herein are described as being for “a product”, this should not be interpreted as limiting the patent packages to covering (e.g., granting a license or obligation of future financial aid) only with respect to a single product. In some embodiments, a single patent package may define a plurality of products to which it applies.

Although process 500 describes a method in which the creation of a patent package begins with identifying a product and identifying patents relevant to the product, in other embodiments different methodologies for initiating or creating a patent package are contemplated. In various embodiments a patent to patent analysis can be the basis for a patent to product analysis. Elements of patents and how they interact or depend on each other can affect the patent to product analysis. For example, a patent that is relevant to another patent can cue how it could be related to a product. For example, in one embodiment: (i) a patent can be related to another patent utilizing a patent relevancy tool; (ii) all of the relevant patents can then be tied to single product or products; and (iii) all of those products can then be related to similar products.

In accordance with some embodiments, relating patents to products may be a complex accumulation of data. Multiplicity is expected, as quantities of patents, products, and services can correlate to each other. For example, thousands of patents may correlate to one product which provides the basis for multiple services. The practical odds of one to one correlation is much lower than multiple to multiple, where the multiples may be similar or magnitudes different. Due to the size of the correlation data and databases expected, the systems, articles of manufacture and methods contemplated herein may complex computer processing technology and algorithms.

In accordance with some alternate embodiments, at least one of the following modes of creating a patent package may be employed:
1. Patent-to-Product Bundling—The patents queried by potential owner/licensors may be used to direct which products are relevant.
2. Hybrid Bundling—A patent or portfolio of patents that are being used by a product provider in association with a product may be used as the basis for performing a relevancy analysis to assemble a patent package.

In accordance with one embodiment, a user (e.g., a product provider) can use search functions provided by the Patent Licensing Server described herein to find patents and products associated with their interests. The user can select and chose from the listing of patents and products, what they would like to bundle into their patent package. The user can be inclusive or exclusive in their selections, based on how much risk they would like to mitigate.

In accordance with some embodiments, a first user (e.g., a product provider of a first product) may select a patent package that has already been created by or for a second user (e.g., a product provider of a second product). For example, the first user may decide to select a package of a competing specific company or select a package in a specific scientific field or technology area.

In accordance with some embodiments, additional patents and products may be continuously or periodically added into the patent licensing system. Users on the back end of the system will most likely continually populate the dataset. A user may make decisions regarding the bundling process or the final patent package on behalf of a third party customer. A back end user may provide services to a front end user regarding the use, tutorial, or other actions relating to the methods, systems and articles of manufacture described herein.

The product relevancy and correlation data may be created from data including but not limited to:
1. An automated system that “crawls” freely available sites, such as corporate websites or database sites (including government databases such as EDGAR™). The automation may include adding updates from those sites.
2. Commercial Databases such as Bloomberg™, Thomson Reuters™, Dunn and Bradstreet™, etc.
3. The UPC code associated of the product. The NAICS/SIC codes of the product may also be included.
4. Professional users who have reviewed the patents and products.

Some example methodologies of correlating patents or products and vice-versa follow:

TABLE 1
Product and Patent correlation

xPatent −> yProduct
xProduct −> yPatent

Where x and y can be any number >0. A product may be related to multiple patents and vice versa. This relationship does not have to be direct, as in the product does not have to absolutely covered by the patent's every element. It can be a partial relationship in a spectrum of relevancy.

TABLE 2
Product and Service correlation

xPatent −> yService
xService −> yPatent
xService −> yProduct
xProduct −> yService

The above situations as are also additive in any combination. For example, xPatent->yService and xService->yProduct can be xPatent->yService->zProduct.

TABLE 3
Product, component and patent correlation

xPatent−>yComponent−> zProduct
xComponent−>y Patent −> zProduct
xComponent−>yProduct−>zPatent
xProduct−>yComponent−>zPatent
xProduct−>yPatent−>zComponent
xPatent−>yProduct−>zComponent

TABLE 4
Service, feature and patent correlation

xPatent−>yFeature−> zService
xFeature−>yService−>zPatent
xFeature−>yPatent−>zService
xService−>yPatent−>zFeature
xService−>yFeature−>zPatent
xPatent−>yService−>zFeature

For both product/component/patent and service/feature/patent correlations, it should be noted that patents may correlate to certain subparts. A subpart of a product is a component. A subpart of a service is a feature. There can be an unlimited number of subparts, which may correlate to multiple products.

For example, a company may manufacture a line of products. Some of these products may all have the identical component. Some of these products may have different components that still correlate to material covered in the same patent. A component may have a service offered by another company. The company offering the service may want to purchase a patent package, which they could find by searching the service->component->product->patent function of the Patent Licensing Service. The patents resulting can be selected or deselected to create a bundled group of patents for the patent package. In accordance with some embodiments, all of the combinations of correlations can be additive.

In another example, assume a software company makes an application that runs on a smartphone. The application may be considered a feature that is an operations application that effects the way a smartphone operates. The company may search the feature->patent->service function of the Patent Licensing Service to understand 1) patents that may need to be bundled from smartphone manufacturers, 2) market players in that service space, 3) patents of the market players in that service space. The company may assemble for itself a patent package that respects the patents of all third parties with which it interact in its business. If the company had one or more patents they were planning on using as a feature, they could also search patent->feature->service.

In accordance with some embodiments, a user searching, for example, service->component->product->patent may or may not see the two intermediate steps. The display may only show the desired start and end information. The database may also be searchable in any order, such as service->product->component->patent and may be able to support a multi-path query.

### Rules of Interpretation

Numerous embodiments have been described, and are presented for illustrative purposes only. The described embodiments are not intended to be limiting in any sense. The invention is widely applicable to numerous embodiments, as is readily apparent from the disclosure herein. These embodiments are described in sufficient detail to enable those skilled in the art to practice the invention, and it is to be understood that other embodiments may be utilized and that structural, logical, software, electrical and other changes may be made without departing from the scope of the present invention. Accordingly, those skilled in the art will recognize that the present invention may be practiced with various modifications and alterations. Although particular features of the present invention may be described with reference to one or more particular embodiments or figures that form a part of the present disclosure, and in which are shown, by way of illustration, specific embodiments of the invention, it should be understood that such features are not limited to usage in the one or more particular embodiments or figures with reference to which they are described. The present disclosure is thus neither a literal description of all embodiments of the invention nor a listing of features of the invention that must be present in all embodiments.

The terms “an embodiment”, “embodiment”, “embodiments”, “the embodiment”, “the embodiments”, “an embodiment”, “some embodiments”, “an example embodiment”, “at least one embodiment”, “one or more embodiments” and “one embodiment” mean “one or more (but not necessarily all) embodiments of the present invention(s)” unless expressly specified otherwise.

The terms “including”, “comprising” and variations thereof mean “including but not limited to”, unless expressly specified otherwise.

The term “consisting of” and variations thereof mean “including and limited to”, unless expressly specified otherwise.

The enumerated listing of items does not imply that any or all of the items are mutually exclusive. The enumerated listing of items does not imply that any or all of the items are collectively exhaustive of anything, unless expressly specified otherwise. The enumerated listing of items does not imply that the items are ordered in any manner according to the order in which they are enumerated.

The term “comprising at least one of” followed by a listing of items does not imply that a component or subcomponent from each item in the list is required. Rather, it means that one or more of the items listed may comprise the item specified. For example, if it is said “wherein A comprises at least one of: a, b and c” it is meant that (i) A may comprise a, (ii) A may comprise b, (iii) A may comprise c, (iv) A may comprise a and b, (v) A may comprise a and c, (vi) A may comprise b and c, or (vii) A may comprise a, b and c.

The terms “a”, “an” and “the” mean “one or more”, unless expressly specified otherwise.

The term “based on” means “based at least on”, unless expressly specified otherwise.

The methods described herein (regardless of whether they are referred to as methods, processes, algorithms, calculations, and the like) inherently include one or more steps. Therefore, all references to a “step” or “steps” of such a method have antecedent basis in the mere recitation of the term ‘method’ or a like term. Accordingly, any reference in a claim to a ‘step’ or ‘steps’ of a method is deemed to have sufficient antecedent basis.

Headings of sections provided in this document and the title are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required, or that each of the disclosed components must communicate with every other component. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described in this document does not, in and of itself, indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

It will be readily apparent that the various methods and algorithms described herein may be implemented by, e.g., appropriately programmed general purpose computers and computing devices. Typically a processor (e.g., a microprocessor or controller device) will receive instructions from a memory or like storage device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media may include dynamic random access memory (DRAM), which typically constitutes the main memory. Transmission media may include coaxial cables, copper wire and fiber optics, including the wires or other pathways that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Transmission Control Protocol, Internet Protocol (TCP/IP), Wi-Fi, Bluetooth, TDMA, CDMA, and 3G.

Where databases are described, it will be understood by one of ordinary skill in the art that (i) alternative database structures to those described may be readily employed, and (ii) other memory structures besides databases may be readily employed. Any schematic illustrations and accompanying descriptions of any sample databases presented herein are illustrative arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, other formats (including relational databases, object-based models and/or distributed databases) could be used to store and manipulate the data types described herein. Likewise, object methods or behaviors of a database can be used to implement the processes of the present invention. In addition, the databases may, in a known manner, be stored locally or remotely from a device that accesses data in such a database.

For example, as an example alternative to a database structure for storing information, a hierarchical electronic file folder structure may be used. A program may then be used to access the appropriate information in an appropriate file folder in the hierarchy based on a file path named in the program.

It should also be understood that, to the extent that any term recited in the claims is referred to elsewhere in this document in a manner consistent with a single meaning, that is done for the sake of clarity only, and it is not intended that any such term be so restricted, by implication or otherwise, to that single meaning.

In a claim, a limitation of the claim which includes the phrase “means for” or the phrase “step for” means that 35 U.S.C. §112, paragraph 6, applies to that limitation.

In a claim, a limitation of the claim which does not include the phrase “means for” or the phrase “step for” means that 35 U.S.C. §112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. §112, paragraph 6, applies to that step(s).

With respect to a means or a step for performing a specified function in accordance with 35 U.S.C. §112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in the present application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. §112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

### CONCLUSION

While various embodiments have been described herein, it should be understood that the scope of the present invention is not limited to the particular embodiments explicitly described. Many other variations and embodiments would be understood by one of ordinary skill in the art upon reading the present description.

What is claimed is:

1. A method for generating a package of patents to include in an offer to a product provider of a product, the method comprising:
(a) receiving at least one text comprising a description of a product;
(b) analyzing the text to identify at least one feature of the product, thereby identifying at least one feature of the product;
(c) searching, for the at least one feature of the product, a memory storing information describing a plurality of patents to identify a plurality of patents related to the at least one feature, thereby identifying a plurality of relevant patents which are relevant to the product;
(d) determining, for each patent of the plurality of relevant patents, a respective relevancy score;
(e) selecting a subset of the plurality of patents based on the respective relevancy scores determined for each patent of the plurality of relevant patents, the subset comprising a predetermined number of patents having the relatively highest relevancy score, thereby determining a set of package patents to include in an offer to a seller of the product;
(f) determining which patents of the set of package patents are included in an inventory of licensable patents, thereby identifying at least one licensed patent to include in the offer;
(g) determining the remainder of the patents of the set of package patents to be at least one not licensed patents to include in the offer; and
(h) outputting to the product provider the offer, the offer comprising a benefit to be provided to the product provider in exchange for a payment from the product provider, the benefit comprising a non-exclusive license to the at least one licensed patents and an agreement for aid to be provided to the product provider in an event of an infringement action initiated against the product provider based on the at least one not licensed patents.

2. The method of claim 1, wherein (d) comprises:
determining, for each patent of the plurality of relevant patents, a respective first relevancy score;
determining, for each patent of the plurality of relevant patents, a respective second relevancy score; and
combining, for each patent of the plurality of relevant patents, the respective first relevancy score and the respective second relevancy score to determine a final relevancy score which is used to select the subset of the plurality of patents.

3. The method of claim 2, wherein combining the respective first relevancy score and the respective second relevancy score comprises averaging the respective first relevancy score and the respective second relevancy score of each patent in the first plurality of relevant patents.

4. The method of 2, wherein the first relevancy score for a particular patent of the plurality of relevant patents is determined based on a comparison of the at least one text to a written description portion of the particular patent.

5. The method of claim 2, wherein the second relevancy score for a particular patent of the plurality of patents is determined based on a comparison of the at least one text to at least one independent claim of the particular patent.

6. The method of claim 1, allocating a portion of the payment to each patent in the set of package patents based at least on the relevancy score, thereby determining a respective payment allocation for each patent.

7. The method of claim 6, further comprising:
for each patent in the set of package patents which is at least one licensed patent, providing the payment allocation to an patent right owner of the patent.

8. The method of claim 6, wherein determining a respective payment allocation for each patent comprises determining a portion of the payment to be divided among the patents included in the offer and apportioning the portion among the patents.

9. The method of claim 6, for each patent in the set of package patents which is at least one not licensed patents, a risk category.

10. The method of claim 9, wherein the risk category is determined based on at least one of (i) an identity of a patent right owner of the patent; (ii) a category of a patent right owner of the patent; (iii) prosecution history information for the patent; (iv) a length of at least one claim in the patent; (v) a number of claims in the patent; (vi) a litigation history of the patent; and (v) an industry category of the product.

11. The method of claim 9, further comprising:
determining, for the at least one not licensed patents and based on the determined risk category, at least one term for the aid defined by the offer, the aid in accordance with the at least one term being provided in exchange for the payment allocation.

12. The method of claim 11, wherein the at least one term comprises a percentage of litigation defense costs which will be reimbursed to the product provider if an infringement action is initiated against the product provider.

13. The method of claim 1, further comprising:
performing step (c) for each feature of the at least one feature, thereby identifying a set of relevant patents for each feature; and
combining the set of patents identified for each feature into a master list of relevant patents for the product, the master set comprising the plurality of relevant patents.

14. The method of claim 1, wherein the payment is a recurring monthly payment.

15. A system for generating a package of patents to include in an offer to a product provider of a product or service, the system comprising:
a processor; and
a memory storing a program for directing the processor, the processor being operable with the program to:
(a) receive at least one text comprising a description of a product;
(b) analyze the text to identify at least one feature of the product, thereby identifying at least one feature of the product;
(c) search, for the at least one feature of the product, a memory storing information describing a plurality of patents to identify a plurality of patents related to the at least one feature, thereby identifying a plurality of relevant patents which are relevant to the product;
(d) determine, for each patent of the plurality of relevant patents, a respective relevancy score;
(e) select a subset of the plurality of patents based on the respective relevancy scores determined for each patent of the plurality of relevant patents, the subset comprising a predetermined number of patents having the relatively highest relevancy score, thereby determining a set of package patents to include in an offer to a product provider of the product;
(f) determine which patents of the set of package patents are included in an inventory of licensable patents, thereby identifying at least one licensed patents to include in the offer;
(g) determine the remainder of the patents of the set of package patents to be at least one not licensed patents to include in the offer; and
(h) output to the product provider the offer, the offer comprising a benefit to be provided to the product provider in exchange for a payment from the product provider, the benefit comprising a non-exclusive license to the at least one licensed patents and an agreement for aid to be provided to the product provider in an event of an infringement action initiated against the product provider based on the at least one not licensed patents.

16. A non-transitory computer readable medium storing instructions for directing a processor to:
(a) receive at least one text comprising a description of a product;
(b) analyze the text to identify at least one feature of the product, thereby identifying at least one feature of the product;
(c) search, for the at least one feature of the product, a memory storing information describing a plurality of patents to identify a plurality of patents related to the at least one feature, thereby identifying a plurality of relevant patents which are relevant to the product;
(d) determine, for each patent of the plurality of relevant patents, a respective relevancy score;
(e) select a subset of the plurality of patents based on the respective relevancy scores determined for each patent of the plurality of relevant patents, the subset comprising a predetermined number of patents having the relatively highest relevancy score, thereby determining a set of package patents to include in an offer to a product provider of the product;
(f) determine which patents of the set of package patents are included in an inventory of licensable patents, thereby identifying at least one licensed patents to include in the offer;
(g) determine the remainder of the patents of the set of package patents to be at least one not licensed patents to include in the offer; and
(h) output to the product provider the offer, the offer comprising a benefit to be provided to the product provider in exchange for a payment from the product provider, the benefit comprising a non-exclusive license to the at least one licensed patents and an agreement for aid to be provided to the product provider in an event of an infringement action initiated against the product provider based on the at least one not licensed patents.
